(19) United States
(12) Patent Application Publication
(10) Pub. No.: US 2026/0254906 A1
(43) Pub. Date: Aug. 27, 2026

(54) IMAGE PROCESSING DEVICE, IMAGE READING APPARATUS, IMAGE PROCESSING SYSTEM, IMAGE PROCESSING METHOD, AND NON-TRANSITORY RECORDING MEDIUM

(71) Applicant: Zentaroh ONO, Tokyo (JP)

(72) Inventor: Zentaroh ONO, Tokyo (JP)

(21) Appl. No.: 19/537,584

(22) Filed: Feb. 12, 2026

(30) Foreign Application Priority Data
Feb. 26, 2025 (JP) 2025-029494

(51) Int. Cl. H04N 1/00; G06T 7/90; H04N 1/60

(52) U.S. Cl. CPC H04N 1/00801; G06T 7/90; H04N 1/00244; H04N 1/00482; H04N 1/00811; H04N 1/60; G06T 2207/10008; G06T 2207/10024; G06T 2207/20081; G06T 2207/30176

(57) ABSTRACT

An image processing device includes circuitry. The circuitry determines a first setting from multiple setting values based on a read image of a subject obtained in full color by a reader reading the subject, and a first trained model. The circuitry converts the read image into an output image based on the first setting.

### CROSS-REFERENCE TO RELATED APPLICATION

This patent application is based on and claims priority pursuant to 35 U.S.C. § 119(a) to Japanese Patent Application No. 2025-029494, filed on Feb. 26, 2025, in the Japan Patent Office, the entire disclosure of which is hereby incorporated by reference herein.

### BACKGROUND

### Technical Field

The present disclosure relates to an image processing device, an image reading apparatus, an image processing system, an image processing method, and a non-transitory recording medium.

### Related Art

Techniques have been developed to automatically determine settings according to a document for an image reading apparatus that obtains an output image by reading the document based on a setting selected from multiple setting values.

### SUMMARY

The present disclosure described herein provides an image processing device including circuitry. The circuitry determines a first setting from multiple setting values based on a read image of a subject obtained in full color by a reader reading the subject, and a first trained model. The circuitry converts the read image into an output image based on the first setting.

The present disclosure described herein provides an image reading apparatus including a reader to read a subject that is a document, and the image processing device described above.

The present disclosure described herein provides an image processing system including the image processing device described above and a server including server circuitry. The server circuitry receives image data relating to the read image from the image processing device via the Internet, and corrects the image data based on an artificial intelligence or generative artificial intelligence. The image processing device receives the corrected image data via the Internet.

The present disclosure described herein provides an image processing method including determining and converting. The determining includes determining a first setting from multiple setting values based on a read image of a subject obtained in full color by a reader reading the subject, and a first trained model. The converting includes converting the read image into an output image based on the first setting.

The present disclosure described herein provides a non-transitory recording medium storing a plurality of instructions which, when executed by one or more processors, causes the one or more processors to perform an image processing method. The method includes determining and converting. The determining includes determining a first setting from multiple setting values based on a read image of a subject obtained in full color by a reader reading the subject, and a first trained model. The converting includes converting the read image into an output image based on the first setting.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a side view of an image reading apparatus according to a first embodiment;

FIG. 2 is a block diagram illustrating a configuration of the image reading apparatus according to the first embodiment;

FIG. 3 is a diagram illustrating a functional configuration of a processor according to the first embodiment;

FIGS. 4A and 4B are diagrams each illustrating training data according to the first embodiment;

FIG. 5 is a diagram illustrating a screen displayed on a control panel;

FIG. 6 is a flowchart of a procedure according to the first embodiment;

FIG. 7 is a flowchart of a procedure for storing training data according to the first embodiment;

FIG. 8 is a diagram illustrating a functional configuration of a processor according to a second embodiment;

FIG. 9 is a diagram illustrating a color area detected by a detection unit;

FIGS. 10A and 10B are diagrams each illustrating training data according to the second embodiment;

FIG. 11 is a flowchart of a procedure according to the second embodiment;

FIG. 12 is a flowchart of a procedure for storing training data according to the second embodiment;

FIG. 13 is a diagram illustrating a functional configuration of a processor according to a third embodiment;

FIG. 14 is a flowchart of a procedure according to the third embodiment;

FIG. 15 is a diagram illustrating a functional configuration of a processor according to a fourth embodiment;

FIGS. 16A and 16B are diagrams each illustrating training data used for training a second trained model; and

FIG. 17 is a flowchart of a procedure according to the fourth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise. The term “connected/coupled” includes both direct connections and connections in which there are one or more intermediate connecting elements.

For the sake of simplicity, identical or similar reference numerals denote identical or similar elements such as parts and materials having the same functions, and redundant descriptions thereof are omitted unless otherwise required.

An image processing device, an image reading apparatus, an image processing system, an image processing method, and a program are described in detail below with reference to the accompanying drawings.

### First Embodiment

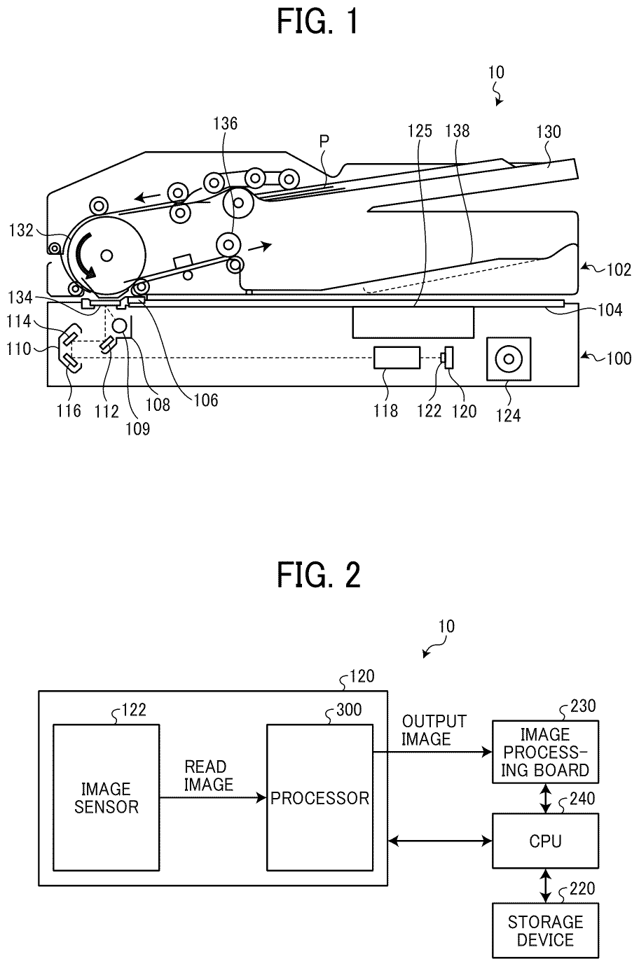

FIG. 1 is a side view of an image reading apparatus 10 according to a first embodiment. The image reading apparatus 10 is, for example, a sheet-through image reading apparatus, and includes a reader body 100, which is a flatbed scanner, and an automatic document feeder (ADF) 102.

The reader body 100 includes a platen 104, a reference white plate 106, a first carriage 108, a second carriage 110, a lens 118, an image sensor 122 disposed on a light-receiving element board 120, a scanner motor 124, and a control panel 125. The first carriage 108 includes a light source 109 and a mirror 112. The second carriage 110 includes mirrors 114 and 116. The reader body 100 includes a reading window 134 for reading a subject P, which is a document conveyed by the ADF 102.

The ADF 102 is disposed above the reader body 100, and automatically feeds and conveys the subject P. The ADF 102 includes a document tray 130, a conveyor drum 132, an output roller 136, and an output tray 138. The ADF 102 conveys the subject P from the document tray 130 toward the conveyor drum 132, which conveys the subject P toward the reading window 134. The subject P is exposed by the light source 109 when passing over the reading window 134. The reflected light from the subject P is redirected by the mirror 112 of the first carriage 108 and the mirrors 114 and 116 of the second carriage 110, then passes through the lens 118, where the light is reduced and focused onto the light-receiving surface of the image sensor 122 on the light-receiving element board 120.

In flatbed reading, the subject P fixed on the platen 104 is scanned by moving the first carriage 108 and second carriage 110, which may be collectively referred to as the “carriages” in the following description. During this process, the subject P on the platen 104 is irradiated from below the platen 104 with light emitted from the light source 109. The reflected light from the subject P is redirected by the mirror 112 of the first carriage 108 and the mirrors 114 and 116 of the second carriage 110, then passes through the lens 118, where the light is reduced and focused onto the light-receiving surface of the image sensor 122 on the light-receiving element board 120. During this process, the image reading apparatus 10 reads the entire subject P by moving the first carriage 108 at a speed V in the sub-scanning direction of the subject P, while the second carriage 110 moves in conjunction with the first carriage 108 at a speed 1/2 V, which is half the speed of the first carriage 108.

The control panel 125 includes a touch panel that displays items such as the setting values of the image reading apparatus 10 and a start button for image reading, and receives user input such as data and instructions to start image reading. The touch panel receives touch input from the user, who can perform operations such as entering numerical values into input boxes displayed on the screen, selecting items from pull-down menus, and turning checkboxes ON or OFF using a finger or a pen, for example. The control panel 125 may further include input devices such as a numeric keypad, trackball, or touchpad.

A configuration of the image reading apparatus 10 is described in detail below. FIG. 2 is a block diagram illustrating a configuration of the image reading apparatus 10 according to the first embodiment. The image reading apparatus 10 includes the light-receiving element board 120, a storage device 220, an image processing board 230, and a central processing unit (CPU) 240.

The light-receiving element board 120 photoelectrically converts the reflected light that has been focused, processes the data of the obtained read image as described later, and outputs the processed data as an output image. The storage device 220 is, for example, a hard disk drive (HDD) or a memory, and stores various data.

The image processing board 230 performs various image processing operations on an output image.

The CPU 240 controls the components of the image reading apparatus 10.

The light-receiving element board 120 includes the image sensor 122 and a processor 300. As described above, the image sensor 122 reads the light image reduced and focused on the light-receiving surface and generates a read image. The processor 300 processes the read image and outputs the resulting output image.

The image sensor 122 is, for example, a complementary metal oxide semiconductor (CMOS) linear image sensor, and reads the subject P in full color. The image sensor 122 includes, for example, three color sensors: red (R), green (G), and blue (B) sensors, which are implemented as line image sensors.

The processor 300 is an example of an image processing device that processes an image. The image sensor 122 is an example of a reader that reads the subject P. The image reading apparatus 10 is an example of an image reading apparatus that includes an image processing device (e.g., the processor 300) and a reader (e.g., the image sensor 122).

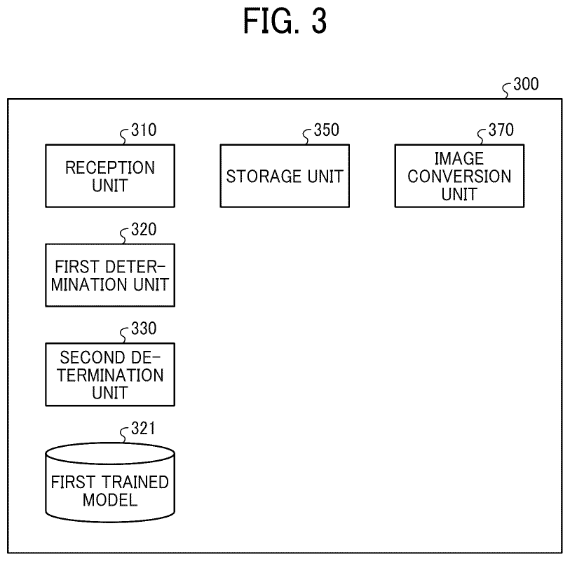

FIG. 3 is a diagram illustrating a functional configuration of the processor 300 according to the first embodiment. As illustrated in FIG. 3, the processor 300 includes a reception unit 310, a first determination unit 320, a second determination unit 330, a first trained model 321, a storage unit 350, and an image conversion unit 370. The units included in the functional configuration may be referred to as functional units.

The reception unit 310 receives input data from the user. For example, the reception unit 310 controls the control panel 125 to receive user input such as data and instructions to start image reading.

The first determination unit 320 determines a first setting from multiple setting values based on a read image of the subject P obtained in full color and the first trained model 321. The multiple setting values refer to values indicating color settings of the output image generated by the processor 300 through conversion of the read image. For example, 1 represents full color, 2 represents monochrome, and 3 represents two colors. In other words, the output image generated by the processor 300 is a full-color image when the setting value is 1, a monochrome image when the setting value is 2, and a two-color image when the setting value is 3. The two-color image refers to, for example, a binary image obtained by binarizing the read image into two colors of white and black.

The first trained model 321 is an artificial intelligence (AI) model (machine learning model) that has been machine-learned using training data including a set of a setting value set by the user for the subject P and a read image of the subject P obtained in full color. Using the first trained model 321 allows determining a color setting according to the subject P.

Machine learning is a technology for enabling a computer to acquire human-like learning capability, and refers to a technique in which the computer autonomously generates algorithms necessary for determination such as data identification from training data incorporated in advance, and applies the algorithms to new data to perform prediction. Any suitable learning method may be employed for machine learning. For example, the learning method may be any of supervised learning, unsupervised learning, semi-supervised learning, reinforcement learning, or deep learning, or a combination of two or more of these methods. No particular limitation is imposed on the learning method for machine learning.

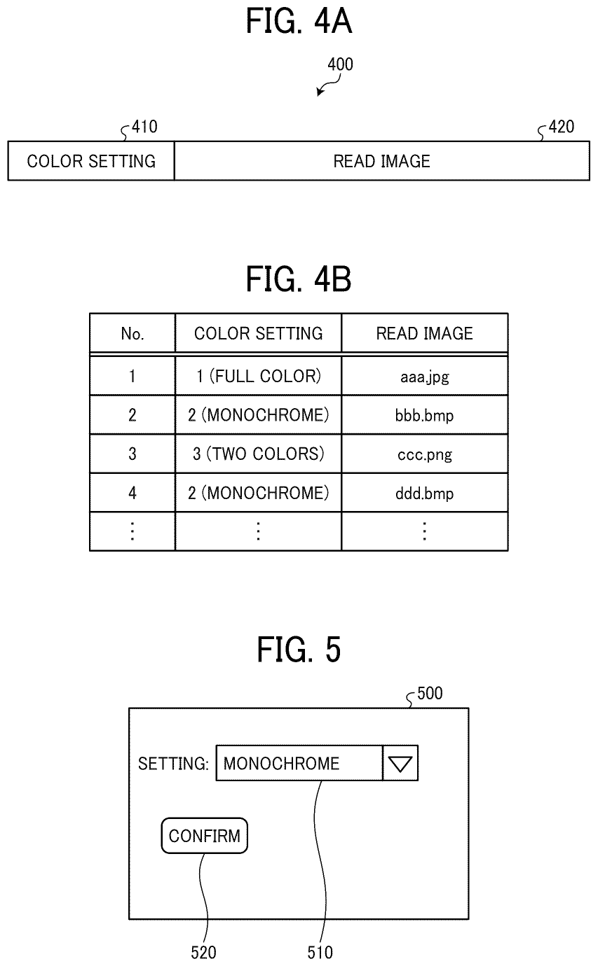

FIGS. 4A and 4B are diagrams each illustrating training data according to the first embodiment. As illustrated in FIG. 4A, each set of training data 400 includes a color setting 410 and a read image 420. The color setting 410 indicates a numerical value such as 1 (full color), 2 (monochrome), or 3 (two colors). The read image 420 indicates image data read in full color. The first trained model 321 is an AI model that has been machine-learned using multiple sets of such training data.

FIG. 4B illustrates multiple sets of training data used for machine learning to train the first trained model 321. For example, training data No. 1 is a read image “aaa.jpg” in which the color setting value “1” is set. Training data No. 2 is a read image “bbb.bmp” in which the color setting value“2” is set. The column of “read image” in FIG. 4B indicates the file name and data format of the read image. In FIG. 4B, “jpg” represents a Joint Photographic Experts Group (JPEG) format, “bmp” represents a bitmap format, and “png” represents a Portable Network Graphics (PNG) format. Files of any other data formats may be used.

The second determination unit 330 determines a second setting from multiple setting values based on the first setting determined by the first determination unit 320 and the input data received by the reception unit 310. The first setting is presented to the user by being displayed on the control panel 125, for example.

FIG. 5 is a diagram illustrating a display screen 500, which is an example of a screen displayed on the control panel 125. As illustrated in FIG. 5, the display screen 500 includes a setting value area 510 and a confirmation button 520. In the setting value area 510, the first setting is displayed as an initial value. In FIG. 5, “monochrome” is displayed as the first setting.

The setting value area 510 illustrated in FIG. 5 is a pull-down menu. The user operates the dropdown menu to change the setting value displayed in the setting value area 510 to a second setting that is different from the first setting. The user presses the confirmation button 520 to input the setting value displayed in the setting value area 510 as the second setting.

As described above, when the reception unit 310 receives the pressing of the confirmation button 520 following a change in the setting value in the setting value area 510, the second determination unit 330 determines a setting value different from the first setting as the second setting. On the other hand, when the reception unit 310 receives the pressing of the confirmation button 520 without a change in the setting value in the setting value area 510, the second determination unit 330 determines the first setting as the second setting. In the present embodiment, the first setting is presented to the user, and the user is allowed to select whether to use the first setting as the color setting or to change the color setting to the second setting. Thus, the color setting can be determined according to the subject P.

The storage unit 350 stores training data used to further train the first trained model 321. The storage unit 350 stores training data by, for example, storing a set of the second setting and the read image in the storage device 220. Storing the set of the second setting and the read image as new training data and additional training of the first trained model 321 using the stored training data enhances the performance of the first determination unit 320 determining the first setting.

The image conversion unit 370 converts the read image into an output image based on the second setting determined by the second determination unit 330. When the color setting indicates “full color,” the image conversion unit 370 generates the output image by maintaining the read image without conversion. When the color setting indicates “monochrome,” the image conversion unit 370 generates the output image by converting the read image into a monochrome image. When the color setting indicates “two colors,” the image conversion unit 370 generates the output image by converting the read image into a binary image of, for example, white and black.

The functional configuration of the present embodiment may be implemented as a first configuration in which the processor 300 does not include the reception unit 310, the second determination unit 330, and the storage unit 350. In this case, the image conversion unit 370 converts the read image into the output image based on the first setting determined by the first determination unit 320, and training data for additional learning is not stored. The functional configuration of the present embodiment may be a second configuration in which the processor 300 does not include the storage unit 350. In this case, the image conversion unit 370 converts the read image into the output image based on the second setting, and training data for additional learning is not stored.

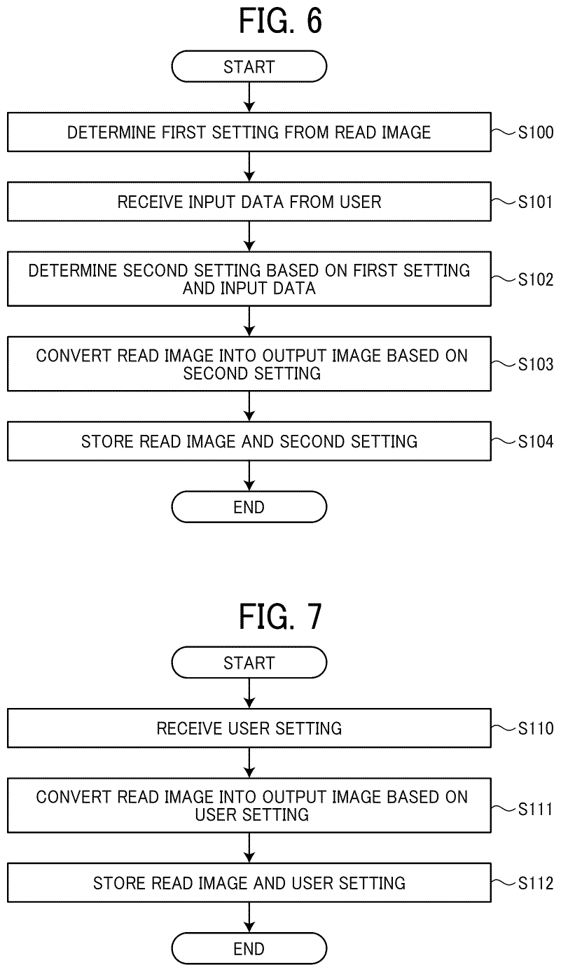

FIG. 6 is a flowchart of a procedure according to the first embodiment. In step S100, the first determination unit 320 determines the first setting from a read image. In step S101, the reception unit 310 receives input data from a user.

In step S102, the second determination unit 330 determines the second setting based on the first setting and the input data. In step S103, the image conversion unit 370 converts the read image into an output image based on the second setting. In step S104, the storage unit 350 stores the read image and the second setting.

When the functional configuration of the present embodiment is implemented as the first configuration, steps S101, S102, and S104 are omitted in FIG. 6 whereas the image conversion unit 370 converts the read image into the output image based on the first setting in step S103. When the functional configuration of the present embodiment is implemented as the second configuration, step S104 is omitted in FIG. 6.

FIG. 7 is a flowchart of a procedure for storing training data according to the first embodiment. A description is given below of storing training data used to train the first trained model 321. In step S110, the reception unit 310 receives a user setting, which is a color setting set by the user according to the subject P. For example, when the image reading apparatus 10 performs a reading process under normal operating conditions, the user inputs a desired color setting according to the subject P to the control panel 125 as a user setting, and the reception unit 310 receives the user setting input to the control panel 125.

In step S111, the image conversion unit 370 converts a read image into an output image based on the user setting. In step S112, the storage unit 350 stores a set of the read image and the user setting as training data. Thus, training data for the first trained model 321 can be stored in parallel with the reading process of the image reading apparatus 10 under normal operating conditions. Training data for the first trained model 321 may alternatively be stored without the reading process of the image reading apparatus 10 under normal operating conditions. In this case, step S111 is omitted in FIG. 7.

As described above, according to the present embodiment, an output image can be obtained with settings according to the subject without a preview scan.

Although the light-receiving element board 120 includes the processor 300, the processor 300 may be external to the light-receiving element board 120. For example, the image processing board 230 may include the processor 300. Typically, the circuit scale of the image processing board 230 is greater than that of the light-receiving element board 120 and is designed with a margin, and thus the image processing board 230 may include the processor 300 without increasing the circuit scale of the image processing board 230.

### Second Embodiment

In a second embodiment, the first determination unit 320 determines the first setting based further on a color area in a read image. In the following description of the second embodiment, descriptions of features identical to those in the first embodiment are omitted, and only features differing from the first embodiment are described.

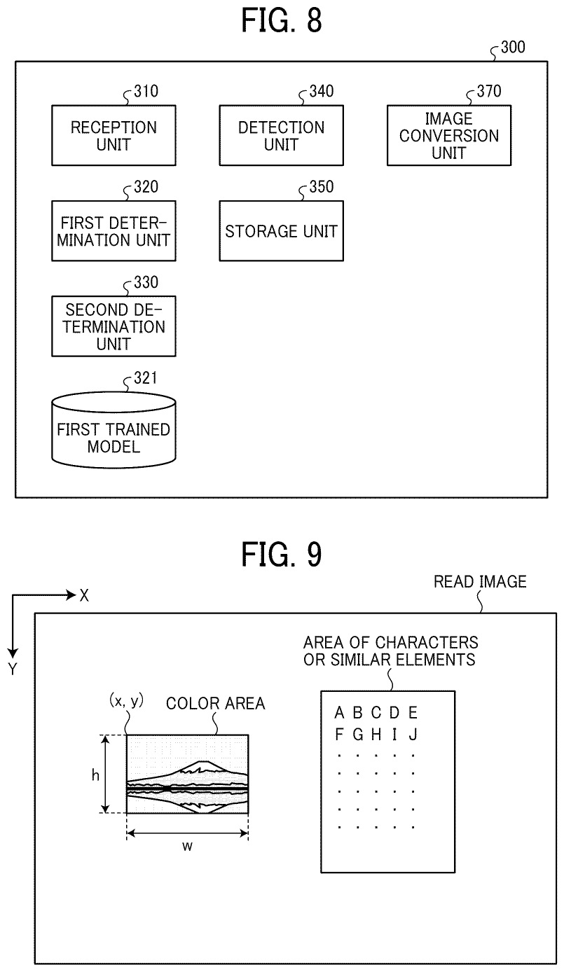

FIG. 8 is a diagram illustrating a functional configuration of the processor 300 according to the second embodiment. The difference from the first embodiment is that the processor 300 further includes a detection unit 340 that detects a color area, and the color area is used in the first determination unit 320, the first trained model 321, and the storage unit 350.

The detection unit 340 detects a color area in a read image. The color area refers to an area of pixels having a saturation greater than a specific value. For example, when pixel values are represented by three values of R, G, and B, the detection unit 340 detects an area in which the magnitudes of the respective values differ from each other as a color area. The detection unit 340 may further detect an area of pixels having a brightness greater than a specific value as a color area. Thus, the detection unit 340 detects, as a color area, an area included in the read image such as a color photograph area or a figure or character area with color tones. This detection identifies, as a monochrome area, an area other than the color area, such as a monochrome photograph area or a figure or character area without color tones.

FIG. 9 is a diagram illustrating a color area detected by the detection unit 340. The read image in FIG. 9 includes a color area and an area of characters or similar elements without color tones. In this example, the detection unit 340 detects a rectangular area as the color area. The X axis and the Y axis are coordinate axes of two dimensional coordinates representing a position on the read image. The rectangle is represented by a position (x, y) of an upper left vertex, a width w, and a height h. In the present embodiment, such a rectangle is represented in the format (x, y, w, h).

The color area that is detected by the detection unit 340 is not limited to a rectangle, and may be a color area having any shape. In this case, the shape of the color area can be represented by, for example, a rectangle including the color area and a binary image in which the value of each pixel in the rectangle is 1 (pixel in the color area) or 0 (pixel outside the color area).

The first determination unit 320 determines the first setting based on the read image, the first trained model 321, and the color area detected by the detection unit 340. The first trained model 321 is an AI model that has been machine-learned using training data including setting values set by the user for the subject P, read images of the subject P obtained in full color, and color areas detected by the detection unit 340. In the present embodiment, using the first trained model 321 allows determining a color setting according to the subject P and the color area of the subject P.

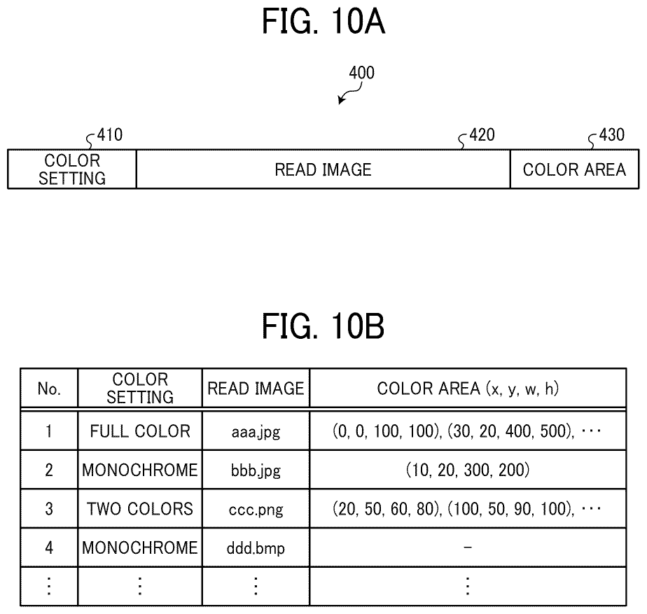

FIGS. 10A and 10B are diagrams each illustrating training data according to the second embodiment. The difference from FIGS. 4A and 4B is that the training data 400 further includes a color area 430 as illustrated in FIG. 10A.

FIG. 10B illustrates multiple sets of training data used for machine learning to train the first trained model 321. As illustrated in FIG. 10B, each set of training data includes a color area detected by the detection unit 340 in the format (x, y, w, h). For example, training data No. 1 includes multiple color areas, such as areas (0, 0, 100, 100) and (30, 20, 400, 500), whereas training data No. 2 includes a color area (10, 20, 300, 200).

The storage unit 350 stores training data used to further train the first trained model 321. The difference from the first embodiment is that the storage unit 350 stores data including a set of a read image, a color area, and the second setting as training data for additional learning.

The functional configuration of the present embodiment may be implemented as a third configuration in which the processor 300 does not include the reception unit 310, the second determination unit 330, and the storage unit 350. In this case, the image conversion unit 370 converts the read image into the output image based on the first setting, and training data for additional learning is not stored. The functional configuration of the present embodiment may be implemented as a fourth configuration in which the processor 300 does not include the storage unit 350. In this case, the image conversion unit 370 converts the read image into the output image based on the second setting, and training data for additional learning is not stored.

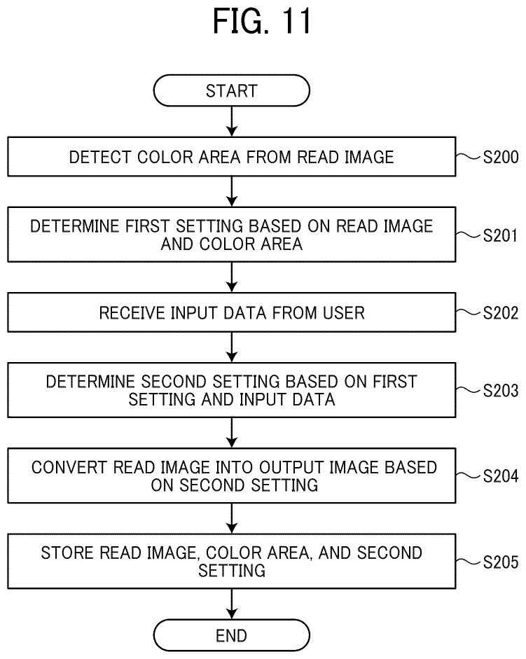

FIG. 11 is a flowchart of a procedure according to the second embodiment. The difference from FIG. 6 is that step S200 for detecting a color area is added, and the color area is used in steps S201 and S205. Since steps S202 to S204 in FIG. 11 are similar to steps S101 to S103 in FIG. 6, the description thereof is omitted.

In step S200, the detection unit 340 detects a color area from a read image. In step S201, the first determination unit 320 determines the first setting using the first trained model 321 based on the read image and the color area.

In step S205, the storage unit 350 stores a set of the read image, the color area, and the second setting as training data for additional learning.

When the functional configuration of the present embodiment is implemented as the third configuration, steps S202, S203, and S205 are omitted in FIG. 11 whereas the image conversion unit 370 converts the read image into the output image based on the first setting in step S204. When the functional configuration of the present embodiment is implemented as the fourth configuration, step S205 is omitted in FIG. 11.

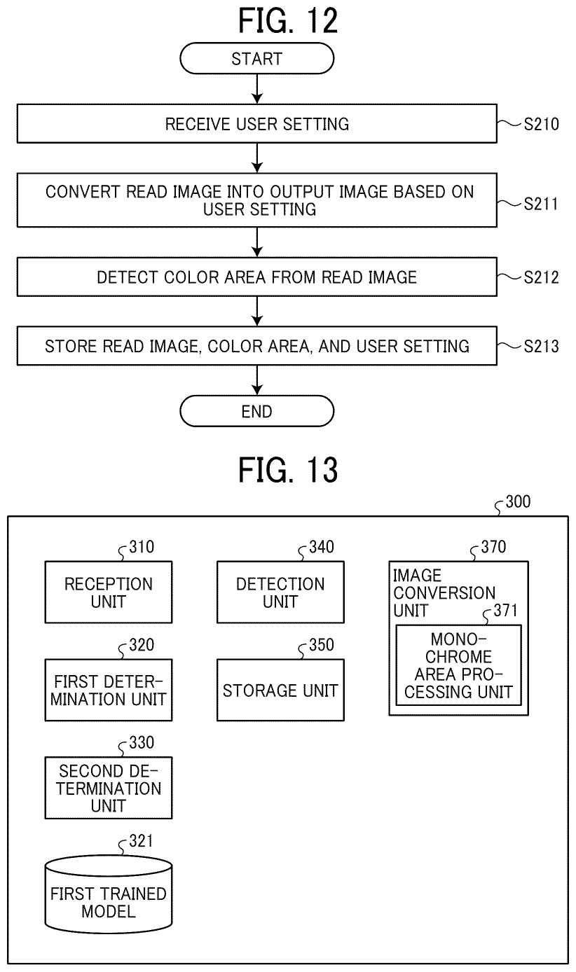

FIG. 12 is a flowchart of a procedure for storing training data according to the second embodiment. A description is given below of storing training data used to train the first trained model 321. The difference from FIG. 7 is that step S212 for detecting a color area is added, and the color area is used in step S213. Since steps S210 and S211 in FIG. 12 are similar to steps S110 and S111 in FIG. 7, the description thereof is omitted.

In step S212, the detection unit 340 detects a color area from a read image. In step S213, the storage unit 350 stores, as training data, data including a set of the read image, the color area, and the user setting. Training data for the first trained model 321 may alternatively be stored without the reading process of the image reading apparatus 10 under normal operating conditions. In this case, step S211 is omitted in FIG. 12.

As described above, according to the present embodiment, an output image can be obtained with settings according to the subject without a preview scan. Further, using the color area detected from the read image allows obtaining settings more appropriately according to the subject.

### Third Embodiment

In a third embodiment, a setting for converting image data that is not included in a color area in a read image into monochrome image data is added as a color setting. In other words, this setting is a setting for converting image data that is included in a monochrome area, which is an area other than a color area, into monochrome image data. This setting may be referred to as “monochrome area processing” in the following description. In the following description of the third embodiment, descriptions of features identical to those in the second embodiment are omitted, and only features differing from the second embodiment are described.

FIG. 13 is a diagram illustrating a functional configuration of the processor 300 according to the third embodiment. The difference from the second embodiment is that the image conversion unit 370 includes a monochrome area processing unit 371 and that multiple setting values processed by the functional units include a setting value of monochrome area processing. The multiple setting values are, for example, 1 (full color), 2 (monochrome), 3 (two colors), and 4 (monochrome area processing).

When the color setting indicates a value (for example, 4) indicating the monochrome area processing, the monochrome area processing unit 371 converts image data included in a monochrome area in a read image into monochrome image data. When the first setting or the second setting indicates 4, the image conversion unit 370 generates the output image by maintaining the image data of the color area as full-color image data and converting the image data of the monochrome area into monochrome image data. The value indicating the monochrome area processing is an example of a predetermined setting value.

The functional configuration of the present embodiment may be a fifth configuration in which the processor 300 does not include the reception unit 310, the second determination unit 330, and the storage unit 350. In this case, the image conversion unit 370 converts the read image into the output image based on the first setting, and training data for additional learning is not stored. The functional configuration of the present embodiment may be implemented as a sixth configuration in which the processor 300 does not include the storage unit 350. In this case, the image conversion unit 370 converts the read image into the output image based on the second setting, and training data for additional learning is not stored.

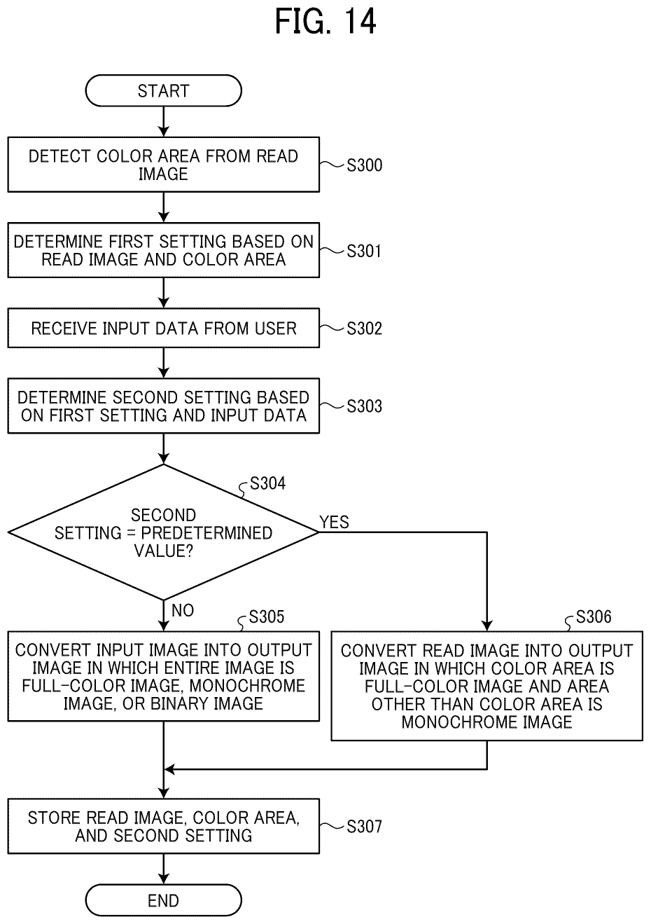

FIG. 14 is a flowchart of a procedure according to the third embodiment. The difference from FIG. 11 is that the processing of converting the read image into the output image is changed to the processing of steps S304 to S306. Since steps S300 to S303 and S307 in FIG. 14 are similar to steps S200 to S203 and S205 in FIG. 11, the description thereof is omitted.

When the second setting does not indicate the predetermined setting value that indicates the monochrome area processing (NO in step S304), the image conversion unit 370 converts the read image into an output image similarly to step S204 in FIG. 11. Specifically, in step S305, the image conversion unit 370 converts the input image into an output image in which the entire image is a full-color image, monochrome image, or binary image, depending on the second setting.

By contrast, when the second setting indicates the predetermined setting value that indicates the monochrome area processing (YES in step S304), in step S306, the image conversion unit 370 converts, with the monochrome area processing unit 371, the read image into an output image in which the color area is a full-color image and the area other than the color area is a monochrome image.

When the functional configuration of the present embodiment is implemented as the fifth configuration, steps S302, S303, and S307 are omitted in FIG. 14 whereas the image conversion unit 370 converts the read image into the output image based on the first setting in steps S305 and S306. When the functional configuration of the present embodiment is implemented as the sixth configuration, step S307 is omitted in FIG. 14.

As described above, according to the present embodiment, an output image can be obtained with settings according to the subject without a preview scan. Further, the setting for converting image data of an area other than the color area into monochrome image data can be used.

### Fourth Embodiment

In a fourth embodiment, image quality of image data included in a color area is enhanced using machine learning. Typically, a read image obtained by a scanner suffers from degradation, such as changes in color tone or distortion, originating from the subject P (document). Such degradation occurs due to factors such as scanning accuracy, contamination such as fingerprints or dust adhering to the glass surface or the document, and mechanical vibrations. Furthermore, when the document itself suffers from degradation, such as stains or smudges, degradation in the read image is unavoidable even with high-precision scanning processes. In the present embodiment, image quality of image data included in a color area is enhanced using machine learning to reduce degradation in the read image. In the following description of the fourth embodiment, descriptions of features identical to those in the second embodiment are omitted, and only features differing from the second embodiment are described.

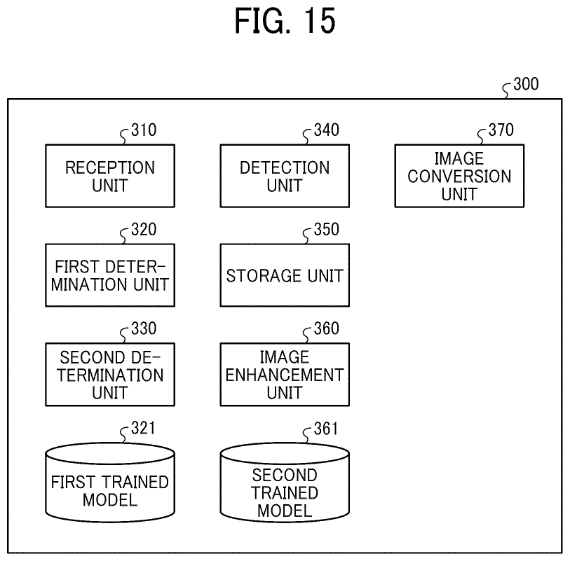

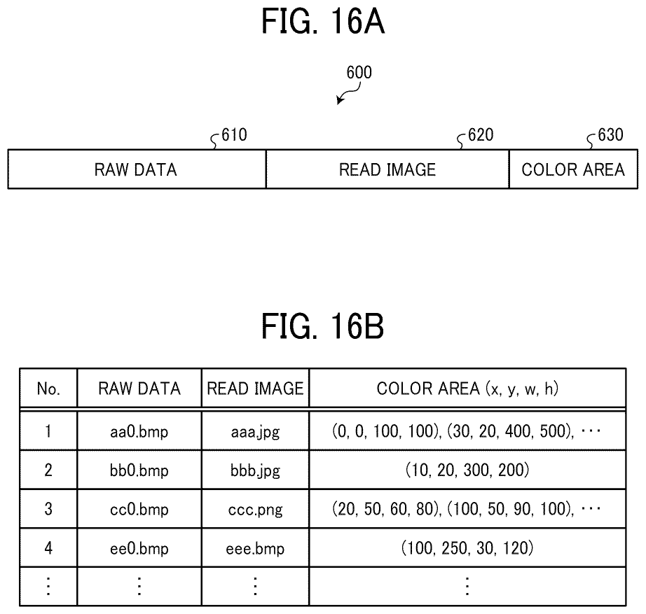

FIG. 15 is a diagram illustrating a functional configuration of the processor 300 according to the fourth embodiment. The difference from the second embodiment is that the processor 300 further includes an image enhancement unit 360 and a second trained model 361.

The image enhancement unit 360 enhances (corrects) image data based on the image data included in a color area and the second trained model 361. More specifically, the image enhancement unit 360 receives image data included in a color area detected by the detection unit 340, and enhances at least one of a change in color tone of the image data and distortion of the image data using the second trained model 361. The enhanced image, which is the read image enhanced by the image enhancement unit 360, is transmitted to the image conversion unit 370. The image conversion unit 370 converts the enhanced image into an output image instead of the read image.

The second trained model 361 is an AI model obtained by any desired machine learning. The second trained model 361 is, for example, a trained neural network whose parameters are adjusted by backpropagation. Alternatively, the second trained model 361 may be a model other than a neural network.

The machine learning for the second trained model 361 is described below. The second trained model 361 is a model that has been machine-learned to capture degradation and image changes based on a comparison between raw data used to generate a document and a read image of the document obtained in full color. The term “raw data” refers to primarily acquired digital data that has not undergone processes such as printing and scanning. The term “degradation” includes deterioration such as changes in color tone, distortion, and loss of contrast or sharpness, whereas the term “image changes” includes variations such as the presence or absence of stains or smudges.

FIGS. 16A and 16B are diagrams each illustrating training data used for training the second trained model 361.

As illustrated in FIG. 16A, each set of training data 600 includes raw data 610, a read image 620 corresponding to the raw data 610, and a color area 630 in the read image 620.

FIG. 16B illustrates multiple sets of training data used for machine learning to train the second trained model 361. For example, training data No. 1 includes raw data “aa0.bmp,” read image “aaa.jpg” corresponding to the raw data “aaa.bmp,” and multiple color areas, such as (0, 0, 100, 100) and (30, 20, 400, 500), in the read image “aaa.jpg.” Training data No. 2 includes raw data “bb0.bmp,” read image “bbb.jpg” corresponding to the raw data “bbo.bmp,” and a color area (10, 20, 300, 200) in the read image “bbb.jpg.”

The image enhancement unit 360 uses the second trained model 361 that has been machine-learned as described above to obtain an enhanced image in which the effects of factors such as scanning accuracy, contamination such as fingerprints or dust adhering to the glass surface or the document, and mechanical vibrations are reduced.

Although the example in which the image enhancement unit 360 performs enhancement processing using the second trained model 361 has been described above, the image enhancement unit 360 may perform enhancement processing using generative artificial intelligence (generative AI) instead of the second trained model 361. The generative AI performs enhancement processing, such as enhancing image quality by removing contamination and generating an image from which contamination has been removed.

The functional configuration of the present embodiment may be implemented as a seventh configuration in which the processor 300 does not include the reception unit 310, the second determination unit 330, and the storage unit 350. In this case, the image conversion unit 370 converts the read image into the output image based on the first setting, and training data for additional learning is not stored. The functional configuration of the present embodiment may be implemented as an eighth configuration in which the processor 300 does not include the storage unit 350. In this case, the image conversion unit 370 converts the read image into the output image based on the second setting, and training data for additional learning is not stored.

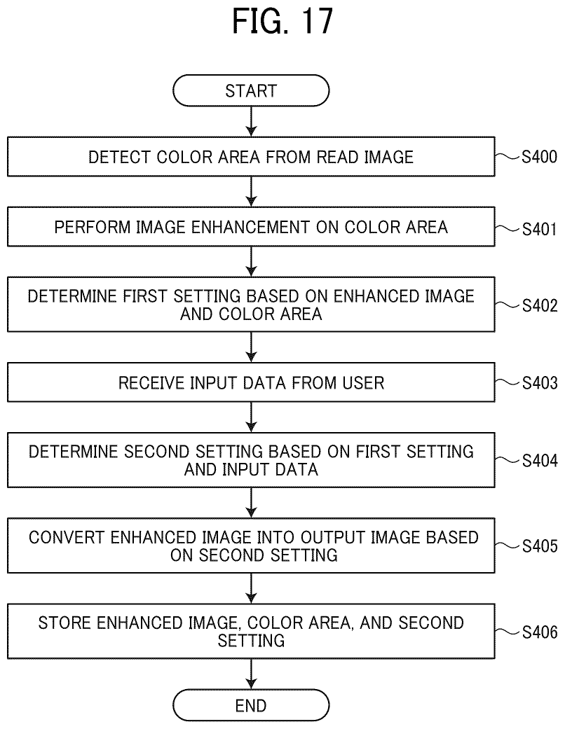

FIG. 17 is a flowchart of a procedure according to the fourth embodiment. The difference from FIG. 11 is that step S401 for enhancing an image is added, and the enhanced image is used instead of the read image in steps S402, S405, and S406. Since steps S400, S403, and S404 in FIG. 17 are similar to steps S200, S202, and S203 in FIG. 11, the description thereof is omitted.

In step S401, the image enhancement unit 360 performs image enhancement of the color area. In step S402, the first determination unit 320 determines the first setting based on the enhanced image and the color area.

In step S405, the image conversion unit 370 converts the enhanced image into an output image based on the second setting. In step S406, the storage unit 350 stores data including a set of the enhanced image, the color area, and the second setting as training data for additional learning.

When the functional configuration of the present embodiment is implemented as the seventh configuration, steps S403, S404, and S406 are omitted in FIG. 17 whereas the image conversion unit 370 converts the read image into the output image based on the first setting in step S405. When the functional configuration of the present embodiment is implemented as the eighth configuration, step S406 is omitted in FIG. 17.

As described above, according to the present embodiment, an output image can be obtained with settings according to the subject without a preview scan. Further, enhancing the image data of the color area and using the enhanced image in which the degradation is reduced allows obtaining settings more appropriately according to the subject.

The program executed by the image processing device according to one or more of the embodiments described above, may be recorded on a computer-readable recording medium, such as a compact disc-read-only memory (CD-ROM), flexible disk (FD), compact disc-recordable (CD-R), or digital versatile disk (DVD), in an installable or executable file format and provided.

The program may alternatively be stored on a computer connected to a network such as the Internet and provided by allowing the program to be downloaded via the network, or may be provided or distributed via a network such as the Internet. Furthermore, part of the functions of the processor 300 that perform processing using AI or generative AI, such as the image enhancement unit 360 and the image conversion unit 370, may be stored on a computer connected to a network such as the Internet and made available to the image processing device via the network. In this case, an image processing system including the image processing device and an external computer may execute the image processing according to one or more of the embodiments described above.

The program may also be provided by being pre-installed in a ROM, for example.

The program executed by the image processing device according to one or more of the embodiments described above is configured as modules including the above-described units (such as the reception unit 310 and the first determination unit 320), and in actual hardware, a CPU (or processor) reads the program from the above-mentioned recording medium and executes the program such that the above units are loaded into the main storage and generated.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a recording medium such as a CD-ROM or DVD, and/or the memory of an FPGA or ASIC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

A description is given below of several aspects of the present disclosure.

According to a first aspect, an image processing device includes a first determination unit and an image conversion unit. The first determination unit determines a first setting from multiple setting values based on a read image of a subject obtained in full color by a reader that reads the subject, and a first trained model. The image conversion unit converts the read image into an output image based on the first setting determined by the first determination unit.

According to a second aspect, the image processing device of the first aspect further includes a reception unit and a second determination unit. The reception unit receives input data from a user. The second determination unit determines a second setting from the multiple setting values based on the first setting determined by the first determination unit and the input data received by the reception unit. The image conversion unit converts the read image into the output image based on the second setting determined by the second determination unit.

According to a third aspect, the image processing device of the second aspect further includes a storage unit that stores training data used to further train the first trained model. The storage unit stores the read image and the second setting.

According to a fourth aspect, the image processing device of the second aspect further includes a detection unit that detects a color area in the read image. The first determination unit determines the first setting based further on the color area detected by the detection unit.

According to a fifth aspect, the image processing device of the third aspect further includes a detection unit that detects a color area in the read image. The first determination unit determines the first setting based further on the color area detected by the detection unit.

According to a sixth aspect, in the image processing device of the fourth or fifth aspect, the image conversion unit converts image data that is not included in the color area in the read image into monochrome image data when the second setting indicates a predetermined setting value.

According to a seventh aspect, the image processing device of the fourth or fifth aspect further includes an image enhancement unit that corrects image data included in the color area based on the image data and a second trained model.

According to an eighth aspect, the image processing device of the fourth or fifth aspect further includes an image enhancement unit that corrects image data included in the color area based on the image data and a generative artificial intelligence.

According to a ninth aspect, in the image processing device of the seventh aspect, the second trained model is a model that has been machine-learned based on raw data used to generate the subject and the read image of the subject obtained in full color.

According to a tenth aspect, in the image processing device of the seventh or eighth aspect, the image enhancement unit corrects at least one of a change in color tone of the image data and distortion of the image data.

According to an eleventh aspect, an image reading apparatus includes a reader that reads a subject that is a document, and the image processing device of any one of the first to tenth aspects.

According to a twelfth aspect, an image processing method executed by an image processing device includes a first determination step and an image conversion step. The first determination step is a step of determining a first setting from multiple setting values based on a read image of a subject obtained in full color by a reader that reads the subject, and a first trained model. The image conversion step is a step of converting the read image into an output image based on the first setting determined in the first determination step.

According to a thirteenth aspect, the image processing method of the twelfth aspect further includes a detection step and an image enhancement step. The detection step is a step of detecting a color area in the read image. The image enhancement step is a step of correcting image data based on the image data and a second trained model.

According to a fourteenth aspect, the image processing method of the twelfth aspect, further includes a detection step and an image enhancement step. The detection step is a step of detecting a color area in the read image. The image enhancement step is a step of correcting image data included in the color area based on the image data and a generative artificial intelligence.

According to a fifteenth aspect, in the image processing method of the thirteenth or fourteenth aspect, the image enhancement step includes correcting at least one of a change in color tone of the image data and distortion of the image data.

According to a sixteenth aspect, a program that causes a computer to function as a first determination unit and an image conversion unit. The first determination unit determines a first setting from multiple setting values based on a read image of a subject obtained in full color by a reader that reads the subject, and a first trained model. The image conversion unit converts the read image into an output image based on the first setting determined by the first determination unit.

According to a seventeenth aspect, the program of the sixteenth aspect further includes a detection unit and an image enhancement unit. The detection unit detects a color area in the read image. The image enhancement unit corrects image data included in the color area based on the image data and a second trained model.

According to an eighteenth aspect, the program of the sixteenth aspect further includes a detection unit and an image enhancement unit. The detection unit detects a color area in the read image. The image enhancement unit corrects image data included in the color area based on the image data and a generative artificial intelligence.

According to a nineteenth aspect, in the program of the seventeenth or eighteenth aspect, the image enhancement unit corrects at least one of a change in color tone of the image data and distortion of the image data.

According to a twentieth aspect, an image processing system includes the image processing device of any one of the first to sixth aspects, and an image enhancement unit that is external to the image processing device and receives image data relating to the read image from the image processing device via the Internet. The image enhancement unit corrects the image data based on an artificial intelligence or generative artificial intelligence. The image processing device receives the image data corrected by the image enhancement unit via the Internet.

1. An image processing device, comprising circuitry configured to:
determine a first setting from multiple setting values based on:
a read image of a subject obtained in full color by a reader reading the subject; and
a first trained model; and
convert the read image into an output image based on the first setting.

2. The image processing device according to claim 1, wherein the circuitry is further configured to:
receive input data from a user;
determine a second setting from the multiple setting values based on the first setting and the input data; and
convert the read image into the output image based on the second setting.

3. The image processing device according to claim 2, further comprising a memory that stores:
training data used to further train the first trained model;
the read image; and
the second setting.

4. The image processing device according to claim 3, wherein the circuitry is further configured to:
detect a color area in the read image; and
determine the first setting based on the color area.

5. The image processing device according to claim 2, wherein the circuitry is further configured to:
detect a color area in the read image; and
determine the first setting based on the color area.

6. The image processing device according to claim 5, wherein the circuitry is configured to convert image data not included in the color area in the read image into monochrome image data when the second setting indicates a predetermined setting value.

7. The image processing device according to claim 5, wherein the circuitry is further configured to correct image data included in the color area based on the image data and a generative artificial intelligence.

8. The image processing device according to claim 5, wherein the circuitry is further configured to correct image data included in the color area based on the image data and a second trained model.

9. The image processing device according to claim 8, wherein the second trained model is a model that has been machine-learned based on raw data used to generate the subject and the read image of the subject obtained in full color.

10. The image processing device according to claim 8, wherein the circuitry is configured to correct at least one of a change in color tone of the image data or distortion of the image data.

11. An image reading apparatus, comprising:
a reader to read a subject, the subject being a document; and
the image processing device according to claim 1.

12. An image processing system, comprising:
the image processing device according to claim 1; and
a server including server circuitry configured to:
receive image data relating to the read image from the image processing device via the Internet; and
correct the image data based on an artificial intelligence or generative artificial intelligence,
wherein the image processing device receives the corrected image data via the Internet.

13. An image processing method, comprising:
determining a first setting from multiple setting values based on:
a read image of a subject obtained in full color by a reader reading the subject; and
a first trained model; and
converting the read image into an output image based on the first setting.

14. The image processing method according to claim 13, further comprising:
detecting a color area in the read image; and
correcting image data included in the color area based on the image data and a second trained model.

15. The image processing method according to claim 14, wherein the correcting includes correcting at least one of a change in color tone of the image data or distortion of the image data.

16. The image processing method according to claim 13, further comprising:
detecting a color area in the read image; and
correcting image data included in the color area based on the image data and a generative artificial intelligence.

17. A non-transitory recording medium storing a plurality of instructions which, when executed by one or more processors, causes the one or more processors to perform an image processing method, the method comprising:
determining a first setting from multiple setting values based on:
a read image of a subject obtained in full color by a reader reading the subject; and
a first trained model; and
converting the read image into an output image based on the first setting.

18. The non-transitory recording medium according to claim 17, wherein the method further comprises:
detecting a color area in the read image; and
correcting image data included in the color area based on the image data and a second trained model.

19. The non-transitory recording medium according to claim 18, wherein the correcting includes correcting at least one of a change in color tone of the image data or distortion of the image data.

20. The non-transitory recording medium according to claim 17, wherein the method further comprises:
detecting a color area in the read image; and
correcting image data included in the color area based on the image data and a generative artificial intelligence.
